(19) United States
(12) Patent Application Publication
(10) Pub. No.: US 2023/0306958 A1
(43) Pub. Date: Sep. 28, 2023

(54) Streaming End-to-end Multilingual Speech Recognition with Joint Language Identification

(71) Applicant: Google LLC, Mountain View, CA (US)

(72) Inventors: Chao Zhang, Mountain View, CA (US); Bo Li, Fremont, CA (US); Tara N. Sainath, Jersey City, NJ (US); Trevor Strohman, Mountain View, CA (US); Sepand Mavandadi, Mountain View, CA (US); Shuo-yiin Chang, 1600 Amphitheatre Parkway, CA (US); Parisa Haghani, Mountain View, CA (US)

(73) Assignee: Google LLC, Mountain View, CA (US)

(21) Appl. No.: 18/188,632

(22) Filed: Mar. 23, 2023

Related U.S. Application Data
(60) Provisional application No. 63/323,944, filed on Mar. 25, 2022.

(51) Int. Cl. G10L 15/00; G10L 15/16; G10L 15/06

(52) U.S. Cl. CPC G10L 15/005; G10L 15/16; G10L 15/063

(57) ABSTRACT

A method includes receiving a sequence of acoustic frames as input to an automatic speech recognition (ASR) model. The method also includes generating, by a first encoder, a first higher order feature representation for a corresponding acoustic frame. The method also includes generating, by a second encoder, a second higher order feature representation for a corresponding first higher order feature representation. The method also includes generating, by a language identification (ID) predictor, a language prediction representation based on a concatenation of the first higher order feature representation and the second higher order feature representation. The method also includes generating, by a first decoder, a first probability distribution over possible speech recognition hypotheses based on a concatenation of the second higher order feature representation and the language prediction representation.

### CROSS REFERENCE TO RELATED APPLICATIONS

This U.S. patent application claims priority under 35 U.S.C. § 119(e) to U.S. Provisional Application 63/323,944, filed on Mar. 25, 2022. The disclosure of this prior application is considered part of the disclosure of this application and is hereby incorporated by reference in its entirety.

### TECHNICAL FIELD

This disclosure relates to streaming end-to-end multilingual speech recognition with joint language identification.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g., a low word error rate (WER)) and latency (e.g., delay between the client speaking and the transcription) based on the ongoing development of deep neural networks. Despite a vast number of people being bilingual, most ASR models are only compatible with a single language. Thus, an ASR model that is compatible with several different languages while still maintaining the accuracy and latency performance metrics of modern ASR models would be desirable for the vast number of bilingual speakers.

### SUMMARY

One aspect of the disclosure provides a multilingual automated speech recognition (ASR) model. The ASR model includes a first encoder configured to receive a sequence of acoustic frames as input and generate, at each of a plurality of output steps, a first higher order feature representation for a corresponding acoustic frame in the sequence of acoustic frames. The ASR model also includes a second encoder configured to receive, as input, the first higher order feature representation generated by the first encoder at each of the plurality of output steps and generate, at each of a plurality of output steps, a second higher order feature representation for a corresponding first higher order feature representation. The ASR model also includes a language identification (ID) predictor configured to receive, as input, a concatenation of the first higher order feature representation generated by the first encoder at each of the plurality of output steps and the second higher order feature representation generated by the second encoder at each of the plurality of output steps and generate a language prediction representation at each of the plurality of output steps. The ASR model also includes a first decoder configured to receive, as input, a concatenation of the second higher order feature representation generated by the second encoder at each of the plurality of output steps and the language prediction representation generated by the language ID predictor at each of the plurality of output steps and generate a first probability distribution over possible speech recognition hypotheses at each of the plurality of output steps.

Implementations of the disclosure may include one or more of the following optional features. In some implementations, the ASR model includes a second decoder configured to receive, as input, the first higher order feature representation generated by the first encoder at each of the plurality of output steps and generate a second probability distribution over possible speech recognition hypotheses at each of the plurality of output steps. Here, the second decoder may be further configured to generate partial speech recognition results based on the second probability distribution over possible speech recognition hypotheses. In these implementations, the first decoder and the second decoder may each include a corresponding prediction network followed by a corresponding joint network, the corresponding prediction networks of the first and second decoders have a same structure including one of a long short-term memory (LSTM)-based prediction network or a V2 embedding look-up table, and the corresponding joint networks of the first and second decoders include a same structure.

In some examples, the second encoder generates the second higher order feature representation without receiving any of the acoustic frames as input. The first encoder includes a causal encoder having one of a plurality of unidirectional long short-term memory (LSTM) layers, a plurality of conformer layers, or a plurality of transformer layers. In some implementations, the second encoder includes a non-causal encoder having one of one or more bi-directional long short-term memory (LSTM) layers, a plurality of conformer layers, or a plurality of transformer layers.

In some implementations, the first encoder, the second encoder, and the language ID predictor are jointly trained on a set of multilingual training utterances by generating a first loss for the first encoder, generating a second loss for the second encoder, generating a third loss for the language ID predictor, and minimizing a weighted sum of the first loss, the second loss, and the third loss. In these implementations, a language ID target token may be added as a first token of a corresponding ground-truth transcription of each multilingual training utterance in the set of multilingual training utterances. The language ID target token identifies a language of the corresponding multilingual training utterance. Alternatively, a language ID target token may be added to each position where a code-switch occurs in a corresponding ground-truth transcription of each multilingual training utterance in the set of multilingual training utterances.

Another aspect of the disclosure provides a computer-implemented method that when executed on data processing hardware causes the data processing hardware to perform operations for streaming end-to-end multilingual speech recognition with joint language identification. The operations include receiving a sequence of acoustic frames as input to an automatic speech recognition (ASR) model. The operations also include generating, at each of a plurality of output steps, a first higher order feature representation by a first encoder of the ASR model for a corresponding acoustic frame in the sequence of acoustic frames. The operations also include generating, at each of the plurality of output steps, a second higher order feature representation by a second encoder of the ASR model for a corresponding first higher order feature representation. The operations also include generating, at each of the plurality of output steps, a language prediction representation by a language identification (ID) predictor of the ASR model. Here, the language prediction representation is based on a concatenation of the first higher order feature representation generated by the first encoder at each of the plurality of output steps and the second higher order feature representation generated by the second encoder at each of the plurality of output steps. The operations also include generating, at each of the plurality of output steps, a first probability distribution over possible speech recognition hypotheses by a first decoder of the ASR model. Here, the first probability distribution over possible speech recognition hypotheses is based on a concatenation of the second higher order feature representation generated by the second encoder at each of the plurality of output steps and the language prediction representation generated by the language ID predictor at each of the plurality of output steps.

Implementations of the disclosure may include one or more of the following optional features. In some implementations, the operations further include generating, at each of the plurality of output steps, a second probability distribution over possible speech recognition hypotheses by a second decoder of the ASR model. The second probability distribution over possible speech recognition hypotheses is based on the first higher order feature representation generated by the first encoder at each of the plurality of output steps. In these implementations, the operations may further include generating, by the second decoder, partial speech recognition results based on the second probability distribution over possible speech recognition hypotheses. The first decoder and the second decoder may each include a corresponding prediction network followed by a corresponding joint network, the corresponding prediction networks of the first and second decoders have a same structure that includes one of long short-term (LSTM)-based prediction network or a V2 embedding look-up table, and the corresponding joint networks of the first and second decoders includes a same structure.

In some examples, the second encoder generates the second higher order feature representation without receiving any of the acoustic frames as input. In some implementations, the first encoder includes a causal encoder that includes one of a plurality of unidirectional long short-term memory (LSTM) layers, a plurality of conformer layers, or a plurality of transformer layers. The second encoder includes a non-causal encoder includes one of one or more bi-directional long short-term memory (LSTM) layers, a plurality of conformer layers, or a plurality of transformer layers.

In some examples, the operations further include jointly training the first encoder, the second encoder, and the language ID predictor on a set of multilingual training utterances by generating a first loss for the encoder, generating second loss for the second encoder, generating a third loss for the language ID predictor, and minimizing a weighted sum of the first loss, the second loss, and the third loss. In these examples, the operations may further include adding a language ID token as a first token of a corresponding ground-truth transcription of each multilingual training utterance in the set of multilingual training utterances. The language ID target token identifies a language of the corresponding multilingual training utterance. Alternatively, the operations further include adding a language ID target token to each position where a code-switch occurs in a corresponding ground-truth transcription of each multilingual training utterance in the set of multilingual training utterances.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIGS. 2A and 2B are schematic views of example speech recognition models.

FIG. 3 is a schematic view of an example prediction network of the example speech recognition models of FIGS. 2A and 2B.

FIGS. 4 and 5 are flowcharts of example arrangements of operations for a computer-implemented method of streaming end-to-end multilingual speech recognition with joint language identification.

FIG. 6 is a schematic view of an example computing device that may be used to implement the systems and methods described herein.

Like reference symbols in the various drawings indicate like elements.

### DETAILED DESCRIPTION

End-to-end (E2E) automatic speech recognition (ASR) models are traditionally structured to operate in either a streaming mode or a non-streaming mode. Conventionally, an E2E ASR model includes an encoder and a decoder as the main components. Applications that involve end-user interaction, like voice-search or on-device dictation, may require the model to perform recognition in a streaming fashion. Here, performing recognition in a streaming fashion refers to the ASR model outputting each word of an utterance as they are spoken with as little latency as possible. Other applications, like offline video captioning, do not require the model to be streaming and can make use of future context to improve performance.

In some implementations, E2E ASR models are configured to recognize speech from multiple languages (e.g., E2E multilingual ASR models). Here, even though multilingual ASR models and language identification models are often used together in downstream tasks (e.g., code-switching and speech translation), the models constructed and executed separately. As such, using both an independent multilingual ASR model and an independent language identification model needlessly complicates the overall ASR system by increasing computational and storage costs.

Accordingly, implementations herein are directed towards an E2E multilingual ASR model that generates transcriptions and language prediction representations together. The ASR model includes a first encoder configured to generate a first higher order feature representation for a corresponding acoustic frame and a second encoder configured to generate a second higher order feature representation for a corresponding first higher order feature representation. The ASR model also includes a language identification predictor configured to receive a concatenation of the first higher order feature representation and the second higher order feature representation and generate a language prediction representation. The ASR model also includes a first decoder configured to receive a concatenation of the second higher order feature representation and the language prediction representation and generate a first probability distribution over possible speech recognition hypotheses (e.g., transcription). Thus, the ASR model (e.g., a single E2E model) outputs both the transcription and the language prediction representation together. Notably, the ASR model never receives or uses any oracle language identification information to generate the transcriptions and the language prediction representations. As will become apparent, the ASR model operates in either the streaming or non-streaming mode for producing the transcriptions and the language prediction representations.

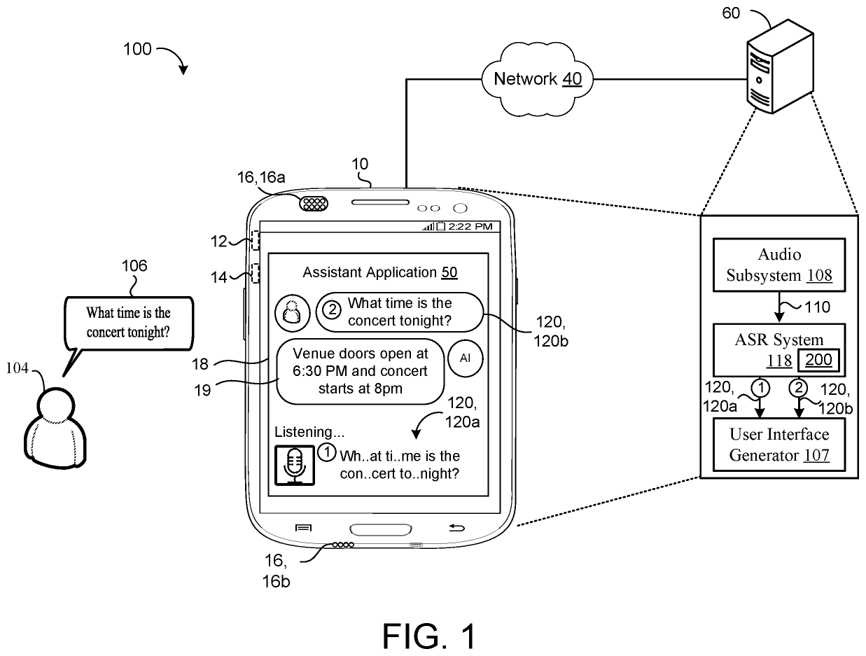

FIG. 1 is an example of a speech environment 100. In the speech environment 100, a user's 104 manner of interacting with a computing device, such as a user device 10, may be through voice input. The user device 10 (also referred to generally as a device 10) is configured to capture sounds (e.g., streaming audio data) from one or more users 104 within the speech environment 100. Here, the streaming audio data may refer to a spoken utterance 106 by the user 104 that functions as an audible query, a command for the user device 10, or an audible communication captured by the device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes an audio system 16 with an audio capture device (e.g., microphone) 16, 16a for capturing and converting spoken utterances 106 with the speech environment 100 into electrical signals and a speech output device (e.g., a speaker) 16, 16b for communicating with an audible audio signal (e.g., as output data from the user device 10). While the user device 10 may implement an array of audio capture devices 16a without departing from the scope of the present disclosure, whereby one or more capture devices 16a in the array may not physically reside on the user device 10, but be in communication with the audio system 16.

In the speech environment 100, an automated speech recognition (ASR) system 118 implements an ASR model 200 and resides on the user device 10 of the user 104 and/or on a remote computing device 60 (e.g., one or more remote servers of a distributed system executing in a cloud-computing environment) in communication with the user device 10 via a network 40. In some examples, the ASR model 200 may be a recurrent neural network-transducer (RNN-T) model. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., sequence of acoustic frames) 110 for input to the ASR system 118. Thereafter, the ASR model 200 receives, as input, the sequence of acoustic frames 110 corresponding to the utterance 106, and generates/predicts, at each output step, a corresponding transcription 120 (e.g., speech recognition result/hypothesis) of the utterance 106 as the ASR model receives (e.g., processes) each acoustic frame 110 in the sequence of acoustic frames 110.

In the example shown, the ASR model 200 may perform streaming speech recognition to produce an initial speech recognition result 120, 120b and generate a final speech recognition result 120, 120a by improving the initial speech recognition result 120b. The speech recognition results 120 may either correspond to a partial speech recognition result or an entire speech recognition result. Stated differently, the speech recognition result 120 may either correspond to a portion of an utterance 106 or an entire utterance 106. For example, the partial speech recognition result may correspond to a portion of a spoken utterance or even a portion of a spoken term. However, as will become apparent, the ASR model 200 performs additional processing on the final speech recognition result 120a whereby the final speech recognition result 120a may be delayed from the initial speech recognition result 120b.

The user device 10 and/or the remote computing device 60 also executes a user interface generator 107 configured to present a representation of the transcription 120 of the utterance 106 to the user 104 of the user device 10. As described in greater detail below, the user interface generator 107 may display the initial speech recognition results 120b in a streaming fashion during time 1 and subsequently display the final speech recognition results 120a in a streaming fashion during time 2. Notably, the ASR model 200 outputs the final speech recognition results 120a in a streaming fashion even though the final speech recognition results 120a improve upon the initial speech recognition result 120b. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the initial speech recognition results 120b. During time 1, the user interface generator 107 presents, via the digital assistant interface 18, a representation of the initial speech recognition results 120b of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 18, a representation of the final speech recognition results 120a of the utterance 106 to the user 104 of the user device 10 a streaming fashion such that words, word pieces, and/or individual characters appear on the screen as soon as they are generated by the ASR model 200. In some implementations, the user interface generator 107 replaces the representation of the initial speech recognition results 120b presented at time 1 with the representation of the final speech recognition results 120a presented at time 2. Here, time 1 and time 2 may include timestamps corresponding to when the user interface generator 107 presents the respective speech recognition result 120. In this example, the timestamp of time 1 indicates that the user interface generator 107 presents the initial speech recognition results 120b at an earlier time than the final speech recognition results 120a. For instance, as the final speech recognition result 120a is presumed to be more accurate than the initial speech recognition result 120b, the final speech recognition result 120a ultimately displayed as the transcription 120 may fix any terms that may have been misrecognized in the initial speech recognition results 120b. In this example, the streaming initial speech recognition results 120b output by the ASR model 200 are displayed on the screen of the user device 10 at time 1 are associated with low latency and provide responsiveness to the user 104 that his/her query is being processed, while the final speech recognition result 120a output by the ASR model 200 and displayed on the screen at time 2 leverages an additional speech recognition model and/or a language model to improve the speech recognition quality in terms of accuracy, but at increased latency. However, since the initial speech recognition results 120b are displayed as the user speaks the utterance 106, the higher latency associated with producing, and ultimately displaying the final speech recognition results 120a is not noticeable to the user 104.

In the example shown in FIG. 1, the digital assistant application 50 may respond to the question posed by the user 104 using natural language processing. Natural language processing generally refers to a process of interpreting written language (e.g., the initial speech recognition result 120b and/or the final speech recognition result 120a) and determining whether the written language prompts any action. In this example, the digital assistant application 50 uses natural language processing to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on a remote server 60 in communication with the data processing hardware 12 of the user device 10.

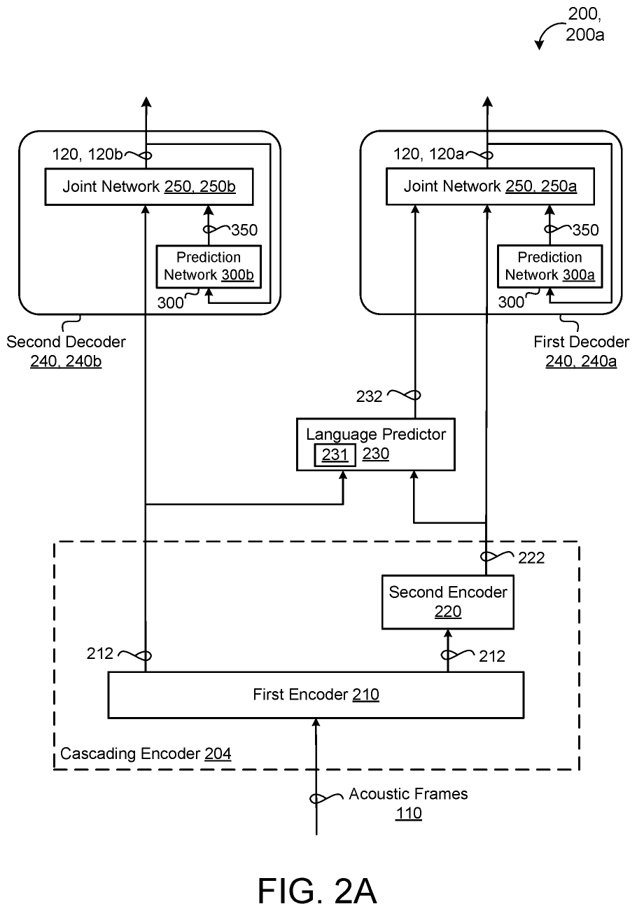

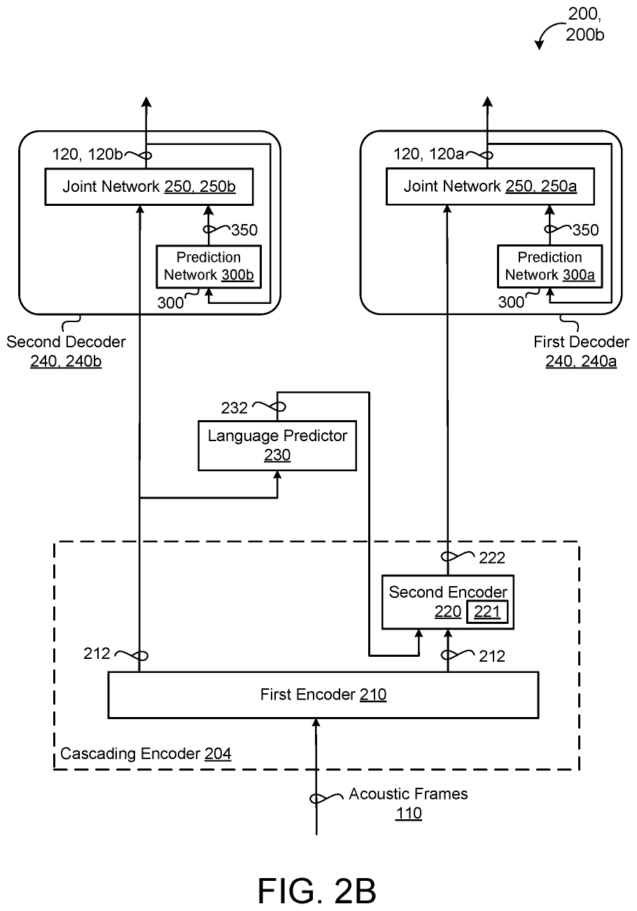

Referring now to FIGS. 2A and 2B, in some implementations, the ASR model 200 includes a cascading encoder 204, a language identification (ID) predictor 230, and decoders 240. Here, a first decoder 240, 240a is configured to improve upon initial speech recognition results 120b output by a second decoder 240, 240b. The second decoder 240b may operate in a streaming fashion such that the second decoder 240b is configured to generate partial speech recognition results corresponding to the initial speech recognition results 120b. On the other hand, the first decoder 240a improves upon the partial speech recognition results by receiving additional right-context and generating the final speech recognition results 120a. The first decoder 240a and the second decoder 240b each include a corresponding prediction network 300 followed by a corresponding joint network 250. Here, the a first prediction network 300, 300a and a first joint network 250, 250a correspond to the first decoder 240a and a second prediction network 300, 300b and a second joint network 250, 250b corresponds to the second decoder 240b. The prediction networks 300a, 300b have a same structure that includes one of a long short-term memory (LSTM)-based prediction network or a V2 embedding look-up table. Moreover, the corresponding joint networks 250a, 250b have a same structure. Although, while the component structure is the same for the first and second decoders 240a, 240b, the respective components of each decoder 240 are unique and may be trained independently from the components of the other decoder 240.

The cascading encoder 204 refers to a model structure where the encoding pathway includes two encoders 210, 220 that cascade such that the output of a first encoder 210 feeds the input of a second encoder 220 prior to decoding. Here, the first encoder 210 and the second encoder 220 may be cascaded irrespective of the underlying architecture of each encoder. The encoders 210, 220 may each include a stack of multi-head attention layers. In some examples, the first encoder 210 includes a causal encoder having one of a plurality of unidirectional (LSTM) layers, a plurality of conformer layers, or plurality of transformer layers. For example, the first encoder 210 may include twelve (12) conformer layers each having a multi-headed (e.g., eight (8) heads) self-attention mechanism and a convolution kernel size of fifteen (15). Moreover, the first encoder 210 may perform a concatenation operation after a third conformer layer to achieve a time reduction rate of two whereby the resulting 1024-dimensional vectors are transformed by a fourth conformer layer and then projected back to a 512-dimensional vector using another linear transformation. Thereafter, another eight (8) conformer layers are followed by a final normalization layer. Thus, the first encoder 210 may include 110 million parameters. Each layer of the first encoder 210 receives zero right-context (e.g., receives zero future acoustic frames).

The second encoder 220 includes a non-causal encoder having one of one or more bi-directional LSTM layers, a plurality of conformer layers, or a plurality of transformer layers. For instance, the second encoder 220 may include a 512-dimensional linear projection to transform input feature, followed by five (5) 512-dimensional conformer layers and a final linear normalization layer thereby resulting in 50 million parameters. Here, the second encoder 220 may receive additional right-context, for example, a total right context of fifteen (15) frames whereby each conformer layer receives three (3) frames of right-context.

With continued reference to FIGS. 2A and 2B, the first encoder 210 receives a sequence of d-dimensional feature vectors (e.g., sequence of acoustic frames 110) x=(x₁, x₂, . . . , x_{T}), where xₜ∈ [symbol] ^{d}, and generates, at each output step, a first higher order feature representation 212 for a corresponding acoustic frame 110 in the sequence of acoustic frames 110. Similarly, the second encoder 220 is connected in cascade to the first encoder 210, and receives the first higher order feature representation 212 as input, and generates, at each output step, a second higher order feature representation 222 for a corresponding first higher order feature representation 212. In some instances, the second encoder 220 generates the second higher order feature representation 222 without receiving any of the acoustic frames 110 as input. In these instances, the second encoder 220 generates the second higher order feature representations 222 using only the first higher order feature representation 212 as input. Thus, the first higher order feature representations 212 output from the first encoder 210 are fed to the language ID predictor 230 and the second decoder 240b while the second higher order feature representations 222 output from the second encoder 220 are fed to the first decoder 240a and the language ID predictor 230. In some configurations, only the second higher order feature representations 222 output from the second encoder 220 is fed to the language ID predictor 230 (FIG. 2B).

With continued reference to FIGS. 2A and 2B, the second decoder 240b includes the second joint network 250b and the second prediction network 300b. The second joint network 250b is configured to receive, as input, a dense representation 350 generated by the second prediction network 300b and the first higher order feature representation 212 generated by the first encoder 210 and generate, at each output step, the initial speech recognition result 120b for a corresponding acoustic frame 110. Here, the second joint network 250b generates the initial speech recognition result 120b using the first higher order feature representation 212 and the dense representation 350. The second decoder 240b operates in a streaming fashion such that the second decoder 240b such that the initial speech recognition results 120b may correspond to partial speech recognition results.

In some implementations, the initial speech recognition result 120b includes a second probability distribution over possible speech recognition hypotheses. As such, the initial speech recognition result 120b may be used interchangeably with the second probability distribution 120b over possible speech recognition hypotheses herein. Thus, the second joint network 250b may generate, at each output step (e.g., time step), a second probability distribution 120b over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-seven (27) symbols, e.g., one label for each of the 26-letters in the English alphabet and one label designating a space. Accordingly, the second joint network 250b may output a set of values indicative of the likelihood of occurrence of each of a predetermined set of output labels. The set of values can be a vector (e.g., a one-hot vector) and can indicate a second probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or sub-phonemes. The second probability distribution 120b of the second joint network 250b can include a posterior probability value for each of the different output labels. Thus, if there are 100 different output labels representing different graphemes or other symbols, the output of the joint network 250 can include 100 different probability values, one for each output label. The second probability distribution 120b can then be used to select and assign scores to candidate orthographic elements (e.g., graphemes, wordpieces, and/or words) in a beam search process (e.g., by a final Softmax layer of the second joint network 250b (not shown)) for determining the initial speech recognition result 120b. For example, the second joint network 250b may select the N-best possible speech recognition hypotheses having the highest probabilities as output for the initial speech recognition result 120b.

In some implementations, the second prediction network 300b receives, as input, a sequence of non-blank symbols output by the final softmax layer of the second joint network 250b and generates, at each output step, a dense representation 350. That is, the second joint network 250b receives the dense representation 350 for the previous initial speech recognition result 120b and generates a subsequent initial speech recognition result 120b using the dense representation 350.

Referring now specifically to FIG. 2A, in some configurations, the language ID predictor 230 of an example ASR model 200, 200a is configured to receive, as input, the first higher order feature representation 212 generated by the first encoder 210 at each of the plurality of output steps and the second higher order feature representation 222 generated by the second encoder 220 at each of the plurality of output steps. Moreover, the language ID predictor 230 may generate a concatenation 231 of the first higher order feature representation 212 and the second higher order feature representation 222. Thereafter, the language ID predictor 230 is further configured to generate, at each of the plurality of output steps, a language prediction representation 232 based on the concatenation 231 of the first higher order feature representation 212 and the second higher order feature representation 222. Advantageously, receiving the concatenation 231 the language ID predictor 230 uses a diversity of inputs to generate the language prediction representation 232.

The language prediction representation 232 indicates a corresponding language of the utterance spoken. For instance, because the ASR model 200 is a multilingual ASR model the spoken utterance may be in any number of languages. Thus, using the concatenation 231, the language ID predictor 230 predicts the corresponding language of the spoken utterance. The language prediction representation 232 may be used for downstream tasks (e.g., code-switching or speech translation) and/or to improve speech recognition results. That is, the first decoder 240a may use the language prediction representation 232 to improve upon the initial speech recognition results 120b generated by the second decoder 240b. In some examples, the language ID predictor 230 generates the language prediction representation 232 on a per-frame basis. In these examples, the spoken utterance may include multiple utterances and the language ID predictor 230 generates the language prediction representation 232 for each acoustic frame 110 in the sequence of acoustic frames 110. For example, for a first portion of the sequence of acoustic frames the language prediction representation 232 may indicate a first language was spoken while for a second portion of the sequence of acoustic frames the language prediction representation 232 indicates a second language was spoken.

With continued reference to FIG. 2A, the first decoder 240a includes the joint first network 250a and the first prediction network 300a. In some configurations, the first joint network 250a is configured to receive, as input, a dense representation 350 generated by the first prediction network 300a, the second higher order feature representation 222 generated by the second encoder 220, and the language prediction representation 232 generated by the language ID predictor 230, and generate, at each output step, the final speech recognition 120a for a corresponding acoustic frame 110. Here, the joint network 250 generates the final speech recognition result 120a using the second higher order feature representation 222, the language prediction representation 232, and the dense representation 350. In some examples, the first decoder 240a generates a concatenation of the second higher order feature representation 222 and the language prediction representation 232 and uses the concatenation to generate the final speech recognition result 120a.

In some implementations, the final speech recognition result 120a includes a first probability distribution over possible speech recognition hypotheses. As such, the final speech recognition result 120a may be used interchangeably with the first probability distribution 120a over possible speech recognition hypotheses herein. Thus, the first joint network 250a may generate, at each output step (e.g., time step), a first probability distribution 120a over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-seven (27) symbols, e.g., one label for each of the 26-letters in the English alphabet and one label designating a space. Accordingly, the first joint network 250a may output a set of values indicative of the likelihood of occurrence of each of a predetermined set of output labels. The set of values can be a vector (e.g., a one-hot vector) and can indicate a first probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or sub-phonemes. The first probability distribution 120a of the first joint network 250a can include a posterior probability value for each of the different output labels. Thus, if there are 100 different output labels representing different graphemes or other symbols, the output of the first joint network 250a can include 100 different probability values, one for each output label. The first probability distribution 120a can then be used to select and assign scores to candidate orthographic elements (e.g., graphemes, wordpieces, and/or words) in a beam search process (e.g., by a final Softmax layer of the first joint network 250a (not shown)) for determining the final speech recognition result 120a. For example, the first joint network 250a may select the N-best possible speech recognition hypotheses having the highest probabilities as output for the final speech recognition result 120a.

In some implementations, the first prediction network 300a receives, as input, a sequence of non-blank symbols output by the final softmax layer of the first joint network 250a and generates, at each output step, a dense representation 350. That is, the first joint network 250a receives the dense representation 350 for the previous final speech recognition result 120a and generates a subsequent final speech recognition result 120a using the dense representation 350.

Referring now specifically to FIG. 2B, in some configurations, the language ID predictor 230 of an example ASR model 200, 200b is configured to receive, as input, the first higher order feature representation 212 generated by the first encoder 210 at each of the plurality of output steps and generate, at each of the plurality of output steps, a language prediction representation 232. Here, the language ID predictor 230 generates the language prediction representation 232 based only on the first higher order feature representation 212 and outputs the language prediction representation 232 to the second encoder 220. Advantageously, in this configuration, both the first decoder 240a and the second encoder 220 benefit from using the language prediction representation 232.

Thus, in these configurations, the second encoder 220 is further configured to receive the first higher order feature representation 212 and the language prediction representation 232 as input, and generate, at each output step, a second higher order feature representation 222 for a corresponding first higher order feature representation 212. The second encoder 220 may generate a concatenation 221 of the first higher order feature representation 212 and the language prediction representation 232 and generate the second higher order feature representation based on the concatenation 221. In some instances, the second encoder 220 generates the second higher order feature representation 222 without receiving any of the acoustic frames 110 as input. In these instances, the second encoder 220 generates the second higher order feature representations 222 using only the first higher order feature representation 212 and the language prediction representation 232.

With continued reference to FIG. 2B, the first decoder 240a includes the joint first network 250a and the first prediction network 300a. In some configurations, the first joint network 250a is configured to receive, as input, a dense representation 350 generated by the first prediction network 300a and the second higher order feature representation 222 generated by the second encoder 220 and generate, at each output step, the final speech recognition 120a for a corresponding acoustic frame 110. Here, the joint network 250 generates the final speech recognition result 120a using the second higher order feature representation 222 and the dense representation 350.

Referring again to both FIGS. 2A and 2B, the language ID predictor 230 generates more accurate language prediction representations 232 using more acoustic information (e.g., longer audio features). Thus, to utilize all past acoustic frames 110 but still generate the language prediction representations 232 on a per-frame basis, the language ID predictor 230 uses non-parametric statistics pooling. That is, the language ID predictor 230 converts the first higher order feature representation 212 into a concatenation of a mean (μₜ) and standard deviation (σₜ) of the first higher order feature representation 212. Notably, the language ID predictor 230 determines the mean and standard deviation in a streaming fashion represented by:

$${μ}_{t} = \frac{θ ( {h}_{1 : t} )}{t} \qquad ( 1 )$$

$${σ}_{t}^{2} = \frac{( θ ( {h}_{1 : t}^{2} ) - 2 {μ}_{t} θ ( {h}_{1 : t} ) + t {μ}_{t}^{2} )}{t} \qquad ( 2 )$$

In Equations 1 and 2, h₁ represents the first higher order feature representation 212. After converting the first higher order feature representation 212 into a concatenated vector [μₜ; σₜ] with statistics pooling, the language ID predictor 230 transforms the concatenated vector into the language prediction representation 232 using two fully connected layers followed by a softmax output layer. As such, the frame-synchronous language ID predictor 230 is efficient for operating in a streaming fashion and only requires a small amount of computational cost during execution.

In some implementations, the ASR model 200 jointly trains the first encoder 210, the second encoder 220, and the language ID predictor 230 on a set of multilingual training utterances. Here, a language ID target token is added as a first token of a corresponding ground-truth transcription of each multilingual training utterance in the set of multilingual training utterance. The language ID target token identifies a language of the corresponding multilingual training utterances. That is, the set of multilingual training utterances may include training utterances in any number of different languages and the language ID target token identifies the actual language (e.g., ground-truth label) of the multilingual training utterance for training purposes.

During training, a training process generates a first loss for the first encoder 210 and a second loss for the second encoder 220 represented by:

$${ℒ}^{r n n t} = ln P ( y \vert {x}_{1 : T} ) \qquad ( 3 )$$

$$P ( y \vert {x}_{1 : T} ) = {\sum }_{\hat{y} ∈ A ( {x}_{1 : T} , y )} {\prod }_{i = 1}^{T + U} P ( {\hat{y}}_{i} \vert {x}_{1 : {t}_{i}} {y}_{1 : {u}_{i}} ) \qquad ( 4 )$$

In Equations 3 and 4, [symbol] ^{rnnt} represents the loss (e.g., Recurrent Neural Network-Transducer loss) of the decoders 240, x represents the sequence of acoustic frames 110, y represents the transcription 120. The ASR model 200 uses two separate decoders 240, and thus, the training loss of the ASR model 200 is represented by

[symbol]

^{casc}=λ [symbol] ^{1st}+(1−λ) [symbol] ^{2nd} (5)

In Equation 5, List represents the loss of the first decoder 240a, [symbol] ^{2nd} represents the loss of the second decoder 240b, λ represents the weighting factor of the loss of the first decoder 240a, and (1−λ) represents the weighting factor of the loss of the second decoder 240b. Moreover, the training process generates a third loss for the language ID predictor 230 represented by:

$${ℒ}^{lid} = {l}_{t} ln ( \frac{{l}_{t}}{{z}_{t}} ) \qquad ( 6 )$$

In Equation 6, [symbol] ^{lid} represents the third loss for the language ID predictor 230 and lₜ represents a one-hot language prediction representation label of t. As such, the training process trains the ASR model 200 using the final training loss according to:

[symbol]

^{asr+lid}= [symbol] ^{casc}+α [symbol] ^{lid} (7)

In Equation 7, α is a scalar weight for the loss for the language ID predictor 230. Thus, the training process trains the ASR model 200 by minimizing a weighted sum of the first loss, the second loss, and the third loss.

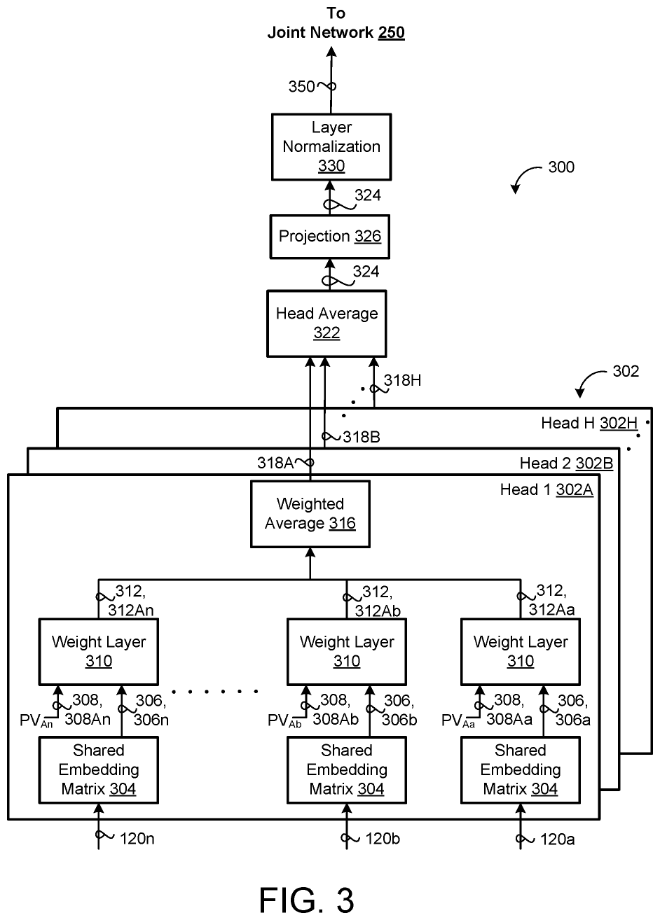

FIG. 3 shows the prediction network 300 either the first or second decoder 240a, 240b (FIG. 2) receiving, as input, a sequence of non-blank symbols that is limited to the N previous non-blank symbols output by the final Softmax layer of the joint network 250. That is, the sequence of non-blank symbols 120, 120a-n output by the final Softmax layer of the joint network 250 may correspond to non-blank symbols of the speech recognition result 120. Thus, the sequence of non-blank symbols 120 and the speech recognition result 120 may be used interchangeably herein. In some examples, N is equal to two. In other examples, N is equal to five, however, the disclosure is non-limiting and N may equal any integer. In some implementations, the prediction network 300 includes a multi-headed attention mechanism 302 that shares a shared embedding matrix 304 across each head 302A-302H of the multi-headed attention mechanism. In one example, the multi-headed attention mechanism 302 includes four heads. However, any number of heads may be employed by the multi-headed attention mechanism 302. Notably, the multi-headed attention mechanism improves performance significantly with minimal increase to model size. As described in greater detail below, each head 302A-H includes its own row of position vectors 308, and rather than incurring an increase in model size by concatenating outputs 318A-H from all the heads, the outputs 318A-H are instead averaged by a head average module 322.

Referring to the first head 302A of the multi-headed attention mechanism 302, the head 302A generates, using the shared embedding matrix 304, a corresponding embedding 306, 306a-n (e.g., X∈ [symbol] ^{d}^{ₑ}) for each non-blank symbol 120 among the sequence of non-blank symbols 120 received as input at the corresponding output step from the plurality of output steps. Notably, since the shared embedding matrix 304 is shared across all heads of the multi-headed attention mechanism 302, the other heads 302B-H all generate the same corresponding embeddings 306 for each non-blank symbol. The head 302A also assigns a respective position vector PV_{Aa-An} 308, 308Aa-An (e.g., P∈ [symbol] ^{H×N×d}^{ₑ}) to each corresponding non-blank symbol in the sequence of non-blank symbols 120. The respective position vector PV 308 assigned to each non-blank symbol indicates a position in the history of the sequence of non-blank symbols (e.g., the N previous non-blank symbols output by the final Softmax layer of the joint network 250). For instance, the first position vector PV_{Aa} is assigned to a most recent position in the history, while the last position vector PV_{An} is assigned to a last position in the history of the N previous non-blank symbols output by the final Softmax layer of the joint network 250. Notably, each of the embeddings 306 may include a same dimensionality (i.e., dimension size) as each of the position vectors PV 308.

While the corresponding embedding generated by the shared embedding matrix 304 for each for each non-blank symbol 120 among the sequence of non-blank symbols 120, is the same at all of the heads 302A-H of the multi-headed attention mechanism 302, each head 302A-H defines a different set/row of position vectors 308. For instance, the first head 302A defines the row of position vectors PV_{Aa-An} 308Aa-An, the second head 302B defines a different row of position vectors PV_{Ba-Bn} 308_{Ba-Bn}, and the H^{th} head 302 H defines another different row of position vectors PV_{Ha-Hn} 308_{Ha-Hn}.

For each non-blank symbol in the sequence of non-blank symbols 120 received, the first head 302A also weights, via a weight layer 310, the corresponding embedding 306 proportional to a similarity between the corresponding embedding and the respective position vector PV 308 assigned thereto. In some examples, the similarity may include a cosine similarity (e.g., cosine distance). In the example shown, the weight layer 310 outputs a sequence of weighted embeddings 312, 312Aa-An each associated the corresponding embedding 306 weighted proportional to the respective position vector PV 308 assigned thereto. Stated differently, the weighted embeddings 312 output by the weight layer 310 for each embedding 306 may correspond to a dot product between the embedding 306 and the respective position vector PV 308. The weighted embeddings 312 may be interpreted as attending over the embeddings in proportion to how similar they are to the positioned associated with their respective position vectors PV 308. To increase computational speed, the prediction network 300 includes non-recurrent layers, and therefore, the sequence of weighted embeddings 312Aa-An are not concatenated, but instead, averaged by a weighted average module 316 to generate, as output from the first head 302A, a weighted average 318A of the weighted embeddings 312Aa-An represented by:

$$Prediction ( X , P ) = \frac{1}{H * N} {\sum }_{h , n} {X}_{n} * {\sum }_{e} ( {X}_{n , e} * {P}_{h , n , e} ) \qquad ( 8 )$$

In Equation 8, h represents the index of the heads 302, n represents position in context, and e represents the embedding dimension. Additionally, in Equation 3, H, N, and dₑ include the sizes of the corresponding dimensions. The position vector PV 308 does not have to be trainable and may include random values. Notably, even though the weighted embeddings 312 are averaged, the position vectors PV 308 can potentially save position history information, alleviating the need to provide recurrent connections at each layer of the prediction network 300.

The operations described above with respect to the first head 302A, are similarly performed by each other head 302B-H of the multi-headed attention mechanism 302. Due to the different set of positioned vectors PV 308 defined by each head 302, the weight layer 310 outputs a sequence of weighted embeddings 312Ba-Bn, 312Ha-Hn at each other head 302B-H that is different than the sequence of weighted embeddings 312Aa-Aa at the first head 302A. Thereafter, the weighted average module 316 generates, as output from each other corresponding head 302B-H, a respective weighted average 318B-H of the corresponding weighted embeddings 312 of the sequence of non-blank symbols.

In the example shown, the prediction network 300 includes a head average module 322 that averages the weighted averages 318A-H output from the corresponding heads 302A-H. A projection layer 326 with SWISH may receive, as input, an output 324 from the head average module 322 that corresponds to the average of the weighted averages 318A-H, and generate, as output, a projected output 328. A final layer normalization 330 may normalize the projected output 328 to provide the single embedding vector 350 at the corresponding time step from the plurality of time steps. The prediction network 300 generates only a single embedding vector 350 at each of the plurality of time steps subsequent to an initial time step.

In some configurations, the prediction network 300 does not implement the multi-headed attention mechanism 302 and only performs the operations described above with respect to the first head 302A. In these configurations, the weighted average 318A of the weighted embeddings 312Aa-An is simply passed through the projection layer 326 and layer normalization 330 to provide the single embedding vector 350.

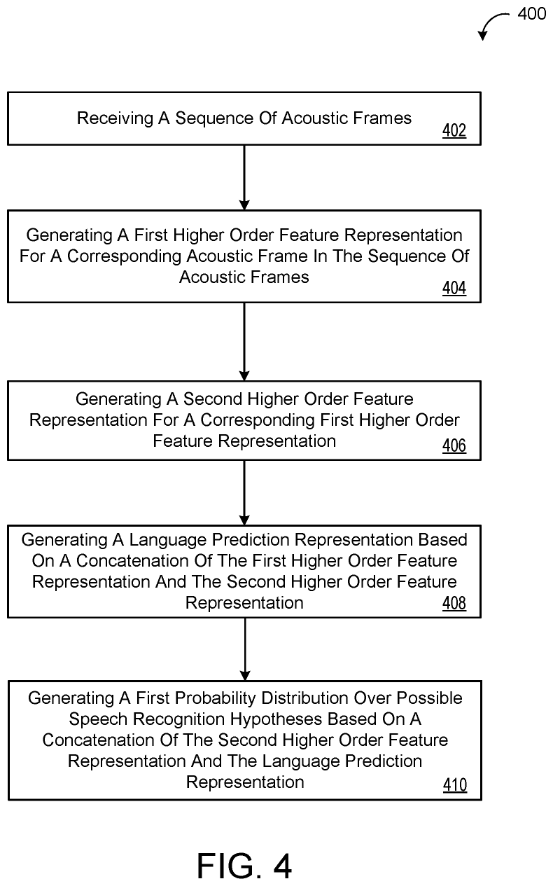

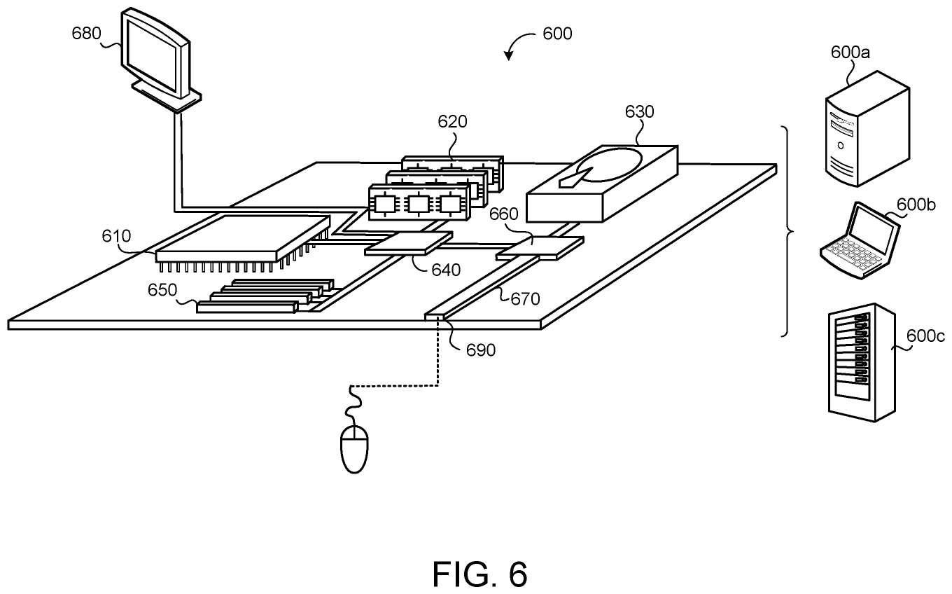

FIG. 4 is a flowchart of an example arrangement of operations for a method 400 of streaming end-to-end multilingual speech recognition with joint language identification. The method 400 may execute on the data processing hardware 610 (FIG. 6) using instructions stored on the memory hardware 620 (FIG. 6). The data processing hardware 610 and the memory hardware 620 may reside on the user device 10 and/or the remote computing device 60 of FIG. 1.

At operation 402, the method 400 includes receiving a sequence of acoustic frames 110 as input to an ASR model 200. At operation 404, the method 400 includes generating, by a first encoder 210 of the ASR model 200 and at each of a plurality of output steps, a first higher order feature representation 212 for a corresponding acoustic frame 110 in the sequence of acoustic frames 110. At operation 406, the method 400 includes generating, by a second encoder 220 of the ASR model 200 and at each of the plurality of output steps, a second higher order feature representation 222 for a corresponding first higher order feature representation 212. At operation 408, the method 400 includes generating, by a language ID predictor 230 of the ASR model 200 and at each of the plurality of output steps, a language prediction representation 232 based on a concatenation 231 of the first higher order feature representation 212 generated by the first encoder 210 at each of the plurality of output steps and the second higher order feature representation 222 generated by the second encoder 220 at each of the plurality of output steps. At operation 410, the method 400 include generating, by a first decoder 240, 240a of the ASR model 200 and at each of the plurality of output steps, a first probability distribution 120a over possible speech recognition hypotheses based on a concatenation of the second higher order feature representation 222 generated by the second encoder 220 at each of the plurality of output steps and the language prediction representation 232 generated by the language ID predictor 230 at each of the plurality of output steps.

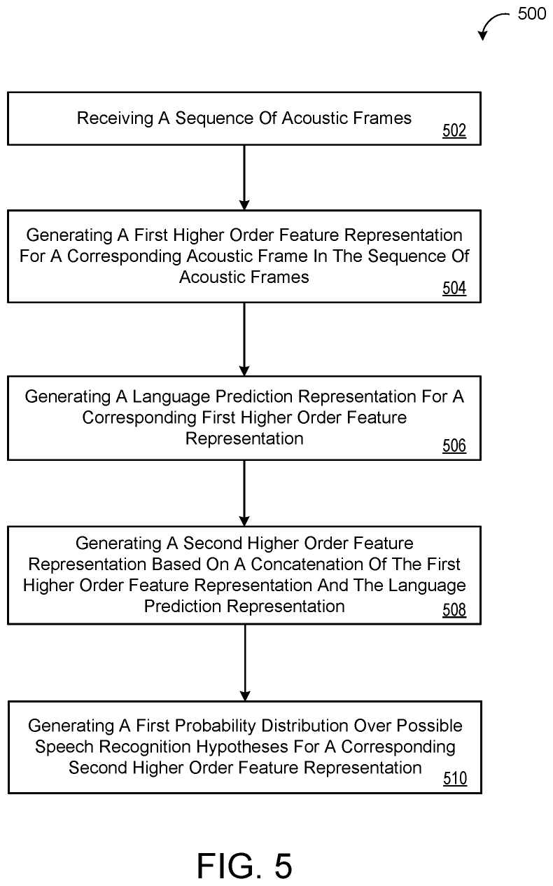

FIG. 5 is a flowchart of an example arrangement of operations for a method 500 of streaming end-to-end multilingual speech recognition with joint language identification. The method 500 may execute on the data processing hardware 610 (FIG. 6) using instructions stored on the memory hardware 620 (FIG. 6). The data processing hardware 610 and the memory hardware 620 may reside on the user device 10 and/or the remote computing device 60 of FIG. 1.

At operation 502, the method 500 includes receiving a sequence of acoustic frames 110 as input to an ASR model 200. At operation 504, the method 500 includes generating, by a first encoder 210 of the ASR model 200 and at each of a plurality of output steps, a first higher order feature representation 212 for a corresponding acoustic frame 110 in the sequence of acoustic frames 110. At operation 506, the method 500 includes generating, by a language ID predictor 230 of the ASR model 200 and at each of the plurality of output steps, a language prediction representation 232 for a corresponding first higher order feature representation 212. At operation 508, the method 500 includes generating, by a second encoder 220 of the ASR model 200 and at each of the plurality of output steps, a second higher feature representation 222 based on a concatenation 221 of the first higher order feature representation 212 generated by the first encoder 210 at each of the plurality of output steps and the language prediction representation 232 generated by the language ID predictor 230 at each of the plurality of output steps. At operation 510, the method 500 includes generating, by a first decoder 240a of the ASR model 200 and at each of the plurality of output steps, a first probability distribution 120a over possible speech recognition hypotheses (e.g., final speech recognition result 120a) for a corresponding second higher order feature representation 222.

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A multilingual automated speech recognition (ASR) model comprising:
a first encoder configured to:
receive, as input, a sequence of acoustic frames; and
generate, at each of a plurality of output steps, a first higher order feature representation for a corresponding acoustic frame in the sequence of acoustic frames;
a second encoder configured to:
receive, as input, the first higher order feature representation generated by the first encoder at each of the plurality of output steps; and
generate, at each of the plurality of output steps, a second higher order feature representation for a corresponding first higher order feature representation;
a language identification (ID) predictor configured to:
receive, as input, a concatenation of the first higher order feature representation generated by the first encoder at each of the plurality of output steps and the second higher order feature representation generated by the second encoder at each of the plurality of output steps; and
generate, at each of the plurality of output steps, a language prediction representation; and
a first decoder configured to:
receive, as input, a concatenation of the second higher order feature representation generated by the second encoder at each of the plurality of output steps and the language prediction representation generated by the language ID predictor at each of the plurality of output steps; and
generate, at each of the plurality of output steps, a first probability distribution over possible speech recognition hypotheses.

2. The ASR model of claim 1, further comprising:
a second decoder configured to:
receive, as input, the first higher order feature representation generated by the first encoder at each of the plurality of output steps; and
generate, at each of the plurality of output steps, a second probability distribution over possible speech recognition hypotheses.

3. The ASR model of claim 2, wherein the second decoder is further configured to generate partial speech recognition results based on the second probability distribution over possible speech recognition hypotheses.

4. The ASR model of claim 2, wherein:
the first decoder and the second decoder each comprise a corresponding prediction network followed by a corresponding joint network;
the corresponding prediction networks of the first and second decoders have a same structure comprising one of:
a long short-term memory (LSTM)-based prediction network; or
a V2 embedding look-up table; and
the corresponding joint networks of the first and second decoders comprise a same structure.

5. The ASR model of claim 1, wherein the second encoder generates the second higher order feature representation without receiving any of the acoustic frames as input.

6. The ASR model of claim 1, wherein the first encoder comprises a causal encoder comprising one of:
a plurality of unidirectional long short-term memory (LSTM) layers;
a plurality of conformer layers; or
a plurality of transformer layers.

7. The ASR model of claim 1, wherein the second encoder comprises a non-causal encoder comprising one of:
one or more bi-directional long short-term memory (LSTM) layers;
a plurality of conformer layers; or
a plurality of transformer layers.

8. The ASR model of claim 1, wherein the first encoder, the second encoder, and the language ID predictor are jointly trained on a set of multilingual training utterances by:
generating a first loss for the first encoder;
generating a second loss for the second encoder;
generating a third loss for the language ID predictor; and
minimizing a weighted sum of the first loss, the second loss, and the third loss.

9. The ASR model of claim 8, wherein a language ID target token is added as a first token of a corresponding ground-truth transcription of each multilingual training utterance in the set of multilingual training utterances, the language ID target token identifying a language of the corresponding multilingual training utterance.

10. The ASR model of claim 8, wherein a language ID target token is added to each position where a code-switch occurs in a corresponding ground-truth transcription of each multilingual training utterance in the set of multilingual training utterances.

11. A computer-implemented method when executed on data processing hardware causes the data processing hardware to perform operations comprising:
receiving, as input to an automatic speech recognition (ASR) model, a sequence of acoustic frames;
generating, by a first encoder of the ASR model, at each of a plurality of output steps, a first higher order feature representation for a corresponding acoustic frame in the sequence of acoustic frames;
generating, by a second encoder of the ASR model, at each of the plurality of output steps, a second higher order feature representation for a corresponding first higher order feature representation;
generating, by a language identification (ID) predictor of the ASR model, at each of the plurality of output steps, a language prediction representation based on a concatenation of the first higher order feature representation generated by the first encoder at each of the plurality of output steps and the second higher order feature representation generated by the second encoder at each of the plurality of output steps; and
generating, by a first decoder of the ASR model, at each of the plurality of output steps, a first probability distribution over possible speech recognition hypotheses based on a concatenation of the second higher order feature representation generated by the second encoder at each of the plurality of output steps and the language prediction representation generated by the language ID predictor at each of the plurality of output steps.

12. The computer-implemented method of claim 11, wherein the operations further comprise generating, by a second decoder of the ASR model, at each of the plurality of output steps, a second probability distribution over possible speech recognition hypotheses based on the first higher order feature representation generated by the first encoder at each of the plurality of output steps.

13. The computer-implemented method of claim 12, wherein the operations further comprise generating, by the second decoder, partial speech recognition results based on the second probability distribution over possible speech recognition hypotheses.

14. The computer-implemented method of claim 12, wherein:
the first decoder and the second decoder each comprise a corresponding prediction network followed by a corresponding joint network;
the corresponding prediction networks of the first and second decoders have a same structure comprising one of:
a long short-term memory (LSTM)-based prediction network; or
a V2 embedding look-up table; and
the corresponding joint networks of the first and second decoders comprise a same structure.

15. The computer-implemented method of claim 11, wherein the second encoder generates the second higher order feature representation without receiving any of the acoustic frames as input.

16. The computer-implemented method of claim 11, wherein the first encoder comprises a causal encoder comprising one of:
a plurality of unidirectional long short-term memory (LSTM) layers;
a plurality of conformer layers; or
a plurality of transformer layers.

17. The computer-implemented method of claim 11, wherein the second encoder comprises a non-causal encoder comprising one of:
one or more bi-directional long short-term memory (LSTM) layers;
a plurality of conformer layers; or
a plurality of transformer layers.

18. The computer-implemented method of claim 11, wherein the operations further comprise jointly training the first encoder, the second encoder, and the language ID predictor on a set of multilingual training utterances by:
generating a first loss for the first encoder;
generating a second loss for the second encoder;
generating a third loss for the language ID predictor; and
minimizing a weighted sum of the first loss, the second loss, and the third loss.

19. The computer-implemented method of claim 18, wherein the operations further comprise adding a language ID target token as a first token of a corresponding ground-truth transcription of each training utterance in the set of multilingual training utterances, the language ID target token identifying a language of the corresponding training utterance.

20. The computer-implemented method of claim 18, wherein the operations further comprise adding a language ID target token to each position where a code-switch occurs in a corresponding ground-truth transcription of each multilingual training utterance in the set of multilingual training utterance.
